(19) United States
(12) Patent Application Publication
(10) Pub. No.: US 2024/0293694 A1
(43) Pub. Date: Sep. 5, 2024

(54) FOAM EXTINGUISHING AGENT RAW LIQUID

(71) Applicant: SENJU METAL INDUSTRY CO., LTD., Tokyo (JP)

(72) Inventors: Toshihiko ORUI, Tokyo (JP); Yuji KAWAMATA, Tokyo (JP)

(73) Assignee: SENJU METAL INDUSTRY CO., LTD., Tokyo (JP)

(21) Appl. No.: 18/592,007

(22) Filed: Feb. 29, 2024

(30) Foreign Application Priority Data
Mar. 2, 2023 (JP) 2023-031595

(51) Int. Cl. A62D 1/00; A62D 1/02

(52) U.S. Cl. CPC A62D 1/0042; A62D 1/0071

(57) ABSTRACT

A foam extinguishing agent raw liquid comprises 14 mass % or more of an anionic surfactant, 0.2 mass % or more and 10 mass % or less of an amphoteric surfactant, 1.0 mass % or more of a nonionic surfactant having HLB of 15 or more, and a solvent. The foam extinguishing agent does not contain a fluorine-based surfactant.

### BACKGROUND

### Technical Field

The present invention relates to a foam extinguishing agent raw liquid containing no fluorine-based surfactant.

### Background Art

Conventionally, there have been proposed various extinguishing agents such as a water extinguishing agent, a reinforcing solution extinguishing agent, a gas extinguishing agent, a powder extinguishing agent, a foam extinguishing agent, and the like. Among them, as a foam extinguishing agent, for example, JP H04-187163 A discloses an extinguishing agent composition containing a fluorine-based surfactant capable of forming liquid crystal in a water film-forming type synthetic interface foam extinguishing agent, a hydrocarbon-based surfactant, and a perfluoroalkyl group and a hydrophilic group-containing fluorine-based copolymer oligomer.

### SUMMARY OF INVENTION

### Problem to be Solved by Invention

The foam extinguishing agent composition disclosed in JP H04-187163 A contains a fluorine-based surfactant, but there is a need to refrain from using fluorine as a raw material of the foam extinguishing agent raw liquid because fluorine itself may adversely affect the environment.

The present invention relates to a foam extinguishing agent raw liquid containing no fluorine-based surfactant and having high fire-extinguishing performance.

### Means for Solving Problem

A foam extinguishing agent raw liquid according to the present invention may comprise 14 mass % or more of an anionic surfactant, 0.2 mass % or more and 10 mass % or less of an amphoteric surfactant, 1.0 mass % or more of a nonionic surfactant having HLB of 15 or more, and a solvent, and
wherein the foam extinguishing agent raw liquid may not contain a fluorine-based surfactant.

In the foam extinguishing agent raw liquid according to the present invention,
the nonionic surfactant may include polyoxyethylene lauryl ether, polyoxyethylene alkyl ether, polyoxyethylene oleyl ether, polyoxyethylene stearyl ether, or polyoxyethylene (7 to 65) undecyl ether.

In the foam extinguishing agent raw liquid according to the present invention,
the nonionic surfactant may have HLB of 18 or more.

In the foam extinguishing agent raw liquid according to the present invention,
the foam extinguishing agent raw liquid may not include an inorganic powder, a silicone component, a metal soap, and a carbonate.

### Effect of Invention

According to the present invention, it is possible to provide a foam extinguishing agent raw liquid containing no fluorine-based surfactant and having high fire-extinguishing performance.

### BRIEF DESCRIPTION OF DRAWINGS

FIG. 1 is a graph showing the relationship between hydrophile-lipophile balance (HLB) of a nonionic surfactant and expansion ratio when 5 parts of the nonionic surfactant is blended;

FIG. 2 is a graph showing the relationship between the HLB of the nonionic surfactant and the expansion ratio when 10 parts of the nonionic surfactant is blended;

FIG. 3 is a graph showing the relationship between the HLB of the nonionic surfactant and the expansion ratio when 20 parts of the nonionic surfactant is blended;

FIG. 4 is a graph showing the relationship between the HLB of the nonionic surfactant and 25% reduction time when 5 parts of the nonionic surfactant is blended;

FIG. 5 is a graph showing the relationship between the HLB of the nonionic surfactant and the 25% reduction time when 10 parts of the nonionic surfactant is blended;

FIG. 6 is a graph showing the relationship between the HLB of the nonionic surfactant and the 25% reduction time when 20 parts of the nonionic surfactant is blended; and

FIG. 7 is a photograph showing how foam remains after extinguishment.

### DETAILED DESCRIPTION

### Description of Embodiments

A foam extinguishing agent raw liquid of the present embodiment contains 14 mass % or more of an anionic surfactant, 0.2 mass % or more of an amphoteric surfactant, 1.0 mass % or more of a nonionic surfactant having HLB of 15 or more, and a solvent.

The foam extinguishing agent raw liquid of the present embodiment need not contain a fluorine-based surfactant. In addition, the foam extinguishing agent raw liquid of the present embodiment need not contain fluorine and a compound containing fluorine as an element (fluorine-containing compound). Since fluorine may adversely affect the environment, it is beneficial that the foam extinguishing agent raw liquid does not contain a fluorine-based surfactant in that the foam extinguishing agent raw liquid can be environmentally friendly. When environmental concerns are emphasized, it is very beneficial that the foam extinguishing agent raw liquid does not contain perfluoroalkyl substances and polyfluoroalkyl substances (PFAS). In the present application, containing no fluorine-containing compound containing fluorine or a fluorine-based surfactant means that the fluorine or fluorine-based surfactant is not contained as a compound to be intentionally added, and does not exclude containing fluorine or a fluorine-containing compound in an amount inevitably mixed. In addition, a reason for not allowing fluorine to be contained despite the fact that seawater contains fluorine is to be environmentally conscious, and fluorine in an amount contained in seawater causes no problem.

Examples of the anionic surfactant include a compound having an arbitrary hydrophilic group such as a carboxylic acid type, a sulfonic acid type, a sulfuric acid ester type, or a phosphoric acid ester type and an arbitrary hydrophobic group such as an aliphatic group or an aromatic group. The content of the anionic surfactant is preferably 14 mass % or more, more preferably 16 mass % or more, and still more preferably 22 mass % or more from the viewpoint of foamability and foam retention. The upper limit of the content of the anionic surfactant is preferably 50 mass % from the viewpoint of solubility to the foam extinguishing agent in the raw liquid.

More specifically, examples of the anionic surfactant include alkylbenzene sulfonic acids such as sodium dodecylbenzene sulfonate or salts thereof, dialkyl sulfosuccinic acids such as sodium diethylhexyl sulfosuccinate and sodium diisotridecyl sulfosuccinate or salts thereof, dipolyoxyethylene alkyl ether sulfosuccinic acids such as sodium di (polyoxyethylene 2-ethylhexyl ether) sulfosuccinate and sodium di (polyoxyethylene isotridecyl ether) sulfosuccinate or salts thereof, polyoxyalkylene alkyl ether sulfuric acids such as sodium polyoxyethylene lauryl ether sulfate and sodium polyoxyethylene myristyl ether sulfate or salts thereof, polyoxyethylene alkyl ether sulfuric acid ester salts such as sodium polyoxyethylene alkyl ether sulfate and ammonium polyoxyethylene alkyl ether sulfate, polyoxyethylene alkyl phenyl ether sulfuric ester acids such as sodium polyoxyethylene alkyl phenyl ether sulfate and ammonium polyoxyethylene alkyl phenyl ether sulfate, polyoxyethylene polycyclic phenyl ether sulfuric acid ester salts such as sodium polyoxyethylene polycyclic phenyl ether sulfate and ammonium polyoxyethylene polycyclic phenyl ether sulfate, polyoxyethylene-polyoxypropylene glycol ether sulfuric acids or salts thereof, alkyl sulfuric acids such as sodium lauryl sulfate, sodium higher alcohol sulfate, triethanolamine lauryl sulfate, and ammonium lauryl sulfate or salts thereof, fatty acids such as potassium oleate, sodium oleate, and sodium semi-cured tallowate or salts thereof, alkyl diphenyl ether disulfonic acids such as diammonium dodecyldiphenyl ether disulfonate, sodium dodecyldiphenyl ether disulfonate, calcium dodecyldiphenyl ether disulfonate, and sodium alkyldiphenyl ether disulfonate or salts thereof, salts of condensates of aromatic sulfonic acid and formaldehyde, salts of condensates of aromatic sulfonic acid and formaldehyde such as sodium naphthalene sulfonate formalin condensate, N-acylsarcosinate salts such as sodium lauroyl sarcosine, higher fatty acid amide sulfonic acids such as sodium N-myristoyl-N-methyl taurine and sodium methyl tauride of coconut oil fatty acid or salts thereof, and N-acyl glutamic acids such as disodium N-stearoyl glutamate and monosodium N-stearoyl glutamate or salts thereof.

Examples of the amphoteric surfactant include an alkyl or alkenyl betaine type, an alkyl or alkenyl amide betaine type, an alkyl or alkenyl sulfobetaine type, an alkyl or alkenyl amide sulfobetaine type, an imidazoline type, an amino acid type, and an amine oxide type compounds or the like, and more specific examples thereof include lauryldimethylamine oxide and lauric acid amidopropyl betaine. The content of the amphoteric surfactant is preferably 0.2 mass % or more, more preferably 1.0 mass % or more, and still more preferably 1.8 mass % or more from the viewpoint of improving the fire-extinguishing performance. The upper limit of the content of the amphoteric surfactant is preferably 10 mass % from the viewpoint of solubility of the surfactant in the diluted solution and deterioration of foamability.

Examples of the nonionic surfactant having HLB of 15 or more include those having HLB of 15 or more among polyoxyethylene lauryl ether, polyoxyethylene alkyl ether, polyoxyethylene oleyl ether, polyoxyethylene stearyl ether, polyoxyethylene (7 to 65) undecyl ether, and the like. The content of the nonionic surfactant having HLB of 15 or more is preferably 1.0 mass % or more, more preferably 2.0 mass % or more, and still more preferably 2.9 mass % or more because foam retention is improved. From the viewpoint of the antifreeze property of the raw liquid of the foam extinguishing agent, the upper limit of the content of the nonionic surfactant having HLB of 15 or more is preferably 30 mass %. The nonionic surfactant having HLB of 18 or more is excellent in that the fire-extinguishing performance is high even when the content of the nonionic surfactant is small (see Table 7 described later). When the HLB is too high, the foam extinguishing agent is not dissolved in the raw liquid. Therefore, the upper limit value of the HLB may be 19.5 or less.

As the solvent, for example, an alkyl betaine type surfactant, isopropyl alcohol, methanol, acetone, methyl ethyl ketone, butoxyethanol, ethyl cellosolve, butyl carbitol, ethylene glycol, ethanol, or the like may be used. The foam extinguishing agent raw liquid may contain water as a solvent, but the content of water is preferably 60 mass % or less from the viewpoint of antifreeze property of the foam extinguishing agent and solubility of higher alcohol.

The foam extinguishing agent raw liquid may contain higher alcohols such as myristyl alcohol and lauryl alcohol, thickeners such as triethanolamine, polyvinylpyrrolidone, and xanthan gum, urea, and the like for improving foam retention.

The foam extinguishing agent raw liquid may contain a neutralizing agent. As the neutralizing agent, for example, sodium hydroxide, potassium hydroxide, sodium carbonate, potassium carbonate, sodium hydrogen carbonate, ammonium hydroxide, ammonia, amine, triethanolamine, 3-dimethylaminoethanol, or the like may be used. Although the foam extinguishing agent raw liquid is sometimes diluted with water to 1 to 6 mass % and used, it is advantageous to use such a neutralizing agent when seawater is used as water.

The foam extinguishing agent raw liquid may contain a rust inhibitor. As the rust inhibitor, for example, 1,2,3-benzotriazole, Na benzoate, or the like may be used.

When the foam extinguishing agent includes an inorganic powder, a silicone component, a metal soap, a carbonate, or the like, foamability and fire-extinguishing performance is deteriorated. Therefore, the foam extinguishing agent raw liquid according to the present embodiment may be an aspect not including an inorganic powder, a silicone component, a metal soap, a carbonate, or the like.

### Examples

The foam extinguishing agent raw liquid was diluted to 3 mass % with synthetic seawater and the diluted solution was filled into a hand spray.

200 ml of water and 20 mL of heptane were put into a stainless steel container having a diameter of 120 mm, and then the mixture was ignited and left as precombustion for 1 minute, and then bubbles were sprayed from all directions with the hand spray, and the fire-extinguishing time was measured.

As a component contained in the foam extinguishing agent raw liquid in Examples and Comparative Examples, triethanolamine lauryl sulfate was used as an anionic surfactant, and lauryldimethylamine oxide was used as an amphoteric surfactant. As the solvent, butyl carbitol was used in addition to water. This butyl carbitol also functions as a foaming improver. Myristyl alcohol was used for improving foam retention, and triethanolamine was used as a neutralizing agent.

In Examples, the expansion ratio and the 25% reduction time were measured while changing the content and components of the nonionic surfactant having HLB of 15 or more. The higher the expansion ratio is, and the longer the 25% reduction time is, the higher the fire-extinguishing performance is. Note that the numerical values shown up to the first decimal place in Tables 1 to 5 are shown as a result of rounding off values of the second decimal place.

Examples 1 to 15 and Comparative Examples 1 to 4 show an aspect in which 5 parts, 10 parts, and 20 parts of a nonionic surfactant are added, but when the contents are expressed as a mass %, the content of the nonionic surfactant being 5 parts means the content of the nonionic surfactant being 4.8 mass %, the content of the nonionic surfactant being 10 parts means the content of the nonionic surfactant being 9.1 mass %, and the content of the nonionic surfactant being 20 parts means the content of the nonionic surfactant being 16.7 mass %.

The other components in Examples 1 to 15 and Comparative Examples 1 to 4 are also converted in mass % as follows. (In the case of 105 parts in total)
Triethanolamine lauryl sulfate: 21.0 mass %
Lauryldimethylamine oxide: 1.7 mass %
Butyl carbitol: 35.2 mass %
Myristyl alcohol: 1.0 mass %
Triethanolamine: 1.9 mass %
Water: 34.5 mass %

(In the case of 110 parts in total)
Triethanolamine lauryl sulfate: 20.0 mass %
Lauryldimethylamine oxide: 1.6 mass %
Butyl carbitol: 33.6 mass %
Myristyl alcohol: 0.9 mass %
Triethanolamine: 1.8 mass %
Water: 33.0 mass %

(In the case of 120 parts in total)
Triethanolamine lauryl sulfate: 18.3 mass %
Lauryldimethylamine oxide: 1.5 mass %
Butyl carbitol: 30.8 mass %
Myristyl alcohol: 0.8 mass %
Triethanolamine: 1.7 mass %
Water: 30.2 mass %

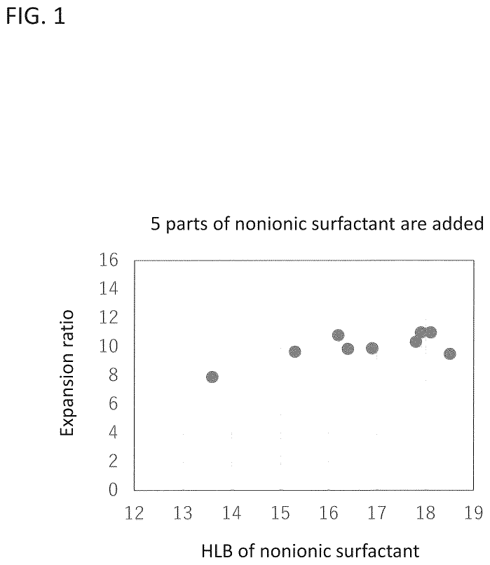

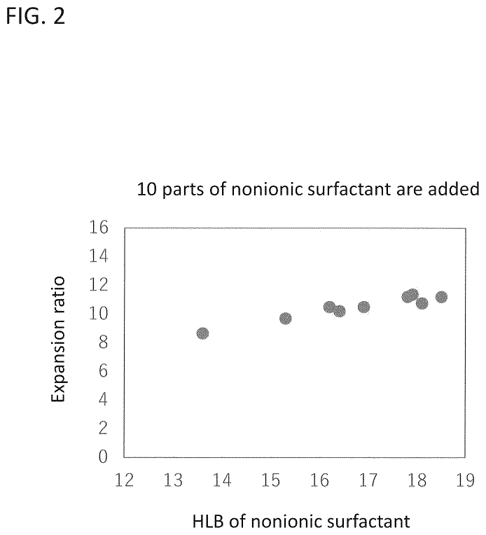

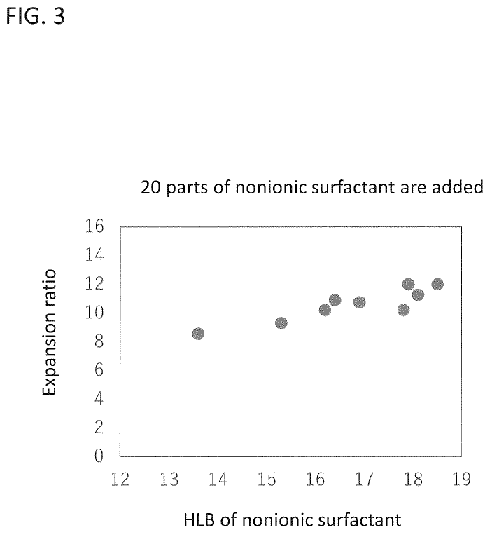

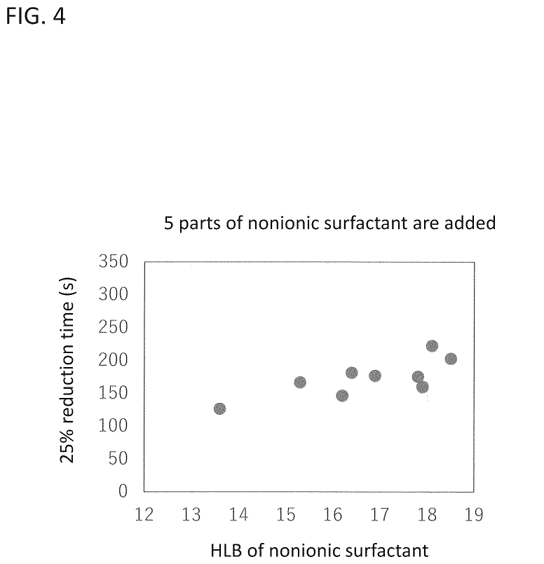

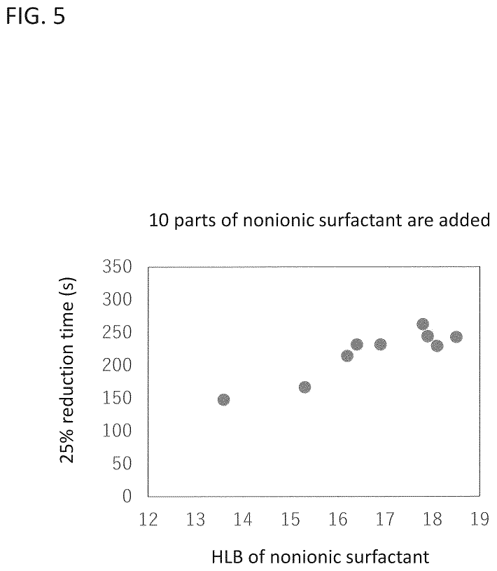

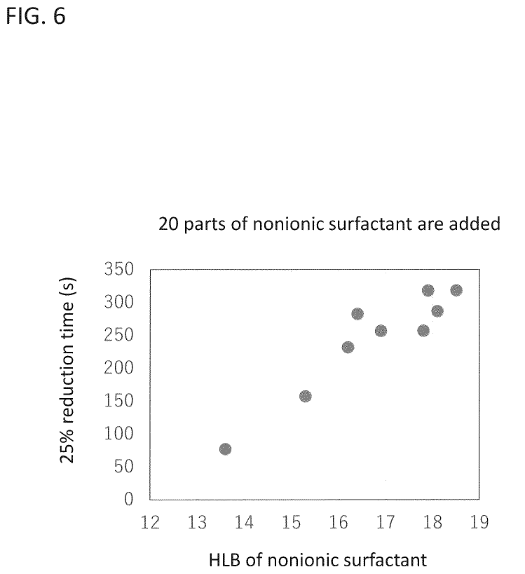

The result of changing the content using polyoxyethylene (12) lauryl ether (HLB: 15.3) is shown in Examples 1 to 3, and the result of changing the content using polyoxyethylene (30) oleyl ether (HLB: 16.2) is shown in Examples 4 to 6. In Comparative Example 1, an aspect without containing a nonionic surfactant is adopted. As compared with Comparative Example 1 and Comparative Examples 2 to 4 described later, in Examples 1 to 6, it was confirmed that the expansion ratio was higher and the 25% reduction time was longer, and it was confirmed that the fire-extinguishing performance was high. Note that FIGS. 1 to 6 are graphs of the results of Examples 1 to 24 and Comparative Examples 1 to 4, which are also to be referred.

TABLE 1

| | | Comparative | | | | | | |
|---|---|---|---|---|---|---|---|---|
| | HLB | Example 1 | Example 1 | Example 2 | Example 3 | Example 4 | Example 5 | Example 6 |
| Triethanolamine lauryl | | 22 | 22 | 22 | 22 | 22 | 22 | 22 |
| sulfate | | | | | | | | |
| Lauryldimethylamine oxide | | 1.8 | 1.8 | 1.8 | 1.8 | 1.8 | 1.8 | 1.8 |
| Butyl carbitol | | 37 | 37 | 37 | 37 | 37 | 37 | 37 |
| Myristyl alcohol | | 1 | 1 | 1 | 1 | 1 | 1 | 1 |
| Triethanolamine | | 2 | 2 | 2 | 2 | 2 | 2 | 2 |
| Polyoxyethylene (12) | 15.3 | | 5 | 10 | 20 | | | |
| lauryl ether | | | | | | | | |
| Polyoxyethylene (30) oleyl | 16.2 | | | | | 5 | 10 | 20 |
| ether | | | | | | | | |
| Water | | 36.3 | 36.3 | 36.3 | 36.3 | 36.3 | 36.3 | 36.3 |
| Total | | 100 | 105 | 110 | 120 | 105 | 110 | 120 |
| Expansion ratio in | | 6.4 | 9.7 | 9.7 | 9.3 | 10.8 | 10.5 | 10.2 |
| synthetic seawater | | | | | | | | |
| 25% reduction time in | | 51 | 167 | 167 | 157.5 | 146.5 | 214.5 | 232 |
| synthetic seawater (s) | | | | | | | | |

The result of changing the content using polyoxyethylene (7 to 30) undecyl ether (HLB: 16.4) is shown in Examples 7 to 9, and the result of changing the content using polyoxyethylene (23) lauryl ether (HLB: 16.9) is shown in Example 10 to 12. Also in Examples 7 to 12, as compared with Comparative Examples 1 to 4, it was confirmed that the expansion ratio was higher and the 25% reduction time was longer, and it was confirmed that the fire-extinguishing performance was high.

TABLE 2

| | HLB | Example 7 | Example 8 | Example 9 | Example 10 | Example 11 | Example 12 |
|---|---|---|---|---|---|---|---|
| Triethanolamine lauryl | | 22 | 22 | 22 | 22 | 22 | 22 |
| sulfate | | | | | | | |
| Lauryldimethylamine oxide | | 1.8 | 1.8 | 1.8 | 1.8 | 1.8 | 1.8 |
| Butyl carbitol | | 37 | 37 | 37 | 37 | 37 | 37 |
| Myristyl alcohol | | 1 | 1 | 1 | 1 | 1 | 1 |
| Triethanolamine | | 2 | 2 | 2 | 2 | 2 | 2 |
| Polyoxyethylene (7 to 30) | 16.4 | 5 | 10 | 20 | | | |
| undecyl ether | | | | | | | |
| Polyoxyethylene (23) laury | 16.9 | | | | 5 | 10 | 20 |
| ether | | | | | | | |
| Water | | 36.3 | 36.3 | 36.3 | 36.3 | 36.3 | 36.3 |
| Total | | 105 | 110 | 120 | 105 | 110 | 120 |
| Expansion ratio in | | 9.9 | 10.2 | 10.9 | 9.9 | 10.5 | 10.8 |
| synthetic seawater | | | | | | | |
| 25% reduction time in | | 181.5 | 232 | 282.5 | 177 | 232 | 256.5 |
| synthetic seawater (s) | | | | | | | |

The result of changing the content using polyoxyethylene (50) stearyl ether (HLB: 17.8) is shown in Examples 13 to 15, and the result of changing the content using polyoxyethylene (20 to 50) undecyl ether (HLB: 17.9) is shown in Examples 16 to 18. Also in Examples 13 to 18, as compared with Comparative Examples 1 to 4, it was confirmed that the expansion ratio was higher and the 25% reduction time was longer, and it was confirmed that the fire-extinguishing performance was high.

TABLE 3

| | HLB | Example 13 | Example 14 | Example 15 | Example 16 | Example 17 | Example 18 |
|---|---|---|---|---|---|---|---|
| Triethanolamine lauryl | | 22 | 22 | 22 | 22 | 22 | 22 |
| sulfate | | | | | | | |
| Lauryldimethylamine oxide | | 1.8 | 1.8 | 1.8 | 1.8 | 1.8 | 1.8 |
| Butyl carbitol | | 37 | 37 | 37 | 37 | 37 | 37 |
| Myristyl alcohol | | 1 | 1 | 1 | 1 | 1 | 1 |
| Triethanolamine | | 2 | 2 | 2 | 2 | 2 | 2 |
| Polyoxyethylene (50) | 17.8 | 5 | 10 | 20 | | | |
| stearyl ether | | | | | | | |
| Polyoxyethylene (20 to 50) | 17.9 | | | | 3.5 | 7 | 14 |
| undecyl ether | | | | | | | |
| Water | | 36.3 | 36.3 | 36.3 | 37.7 | 39.2 | 42.2 |
| Total | | 105 | 110 | 120 | 105 | 110 | 120 |
| Expansion ratio in synthetic | | 10.4 | 11.2 | 10.2 | 11.0 | 11.4 | 12.0 |
| seawater | | | | | | | |
| 25% reduction time in | | 175.5 | 262.5 | 257 | 160 | 244 | 318 |
| synthetic seawater (s) | | | | | | | |

The nonionic surfactants in Examples 16 to 18 are converted in mass % as follows.

In the case of Example 16 (105 parts in total): 3.3 mass %

In the case of Example 17 (110 parts in total): 6.4 mass %

In the case of Example 18 (120 parts in total): 11.7 mass %

The result of changing the content using polyoxyethylene (41) lauryl ether (HLB: 18.1) is shown in Examples 19 to 21, and the result of changing the content using polyoxyethylene (35 to 65) undecyl ether (HLB: 18.5) is shown in Examples 22 to 24. Also in Examples 19 to 24, as compared with Comparative Examples 1 to 4, it was confirmed that the expansion ratio was higher and the 25% reduction time was longer, and it was confirmed that the fire-extinguishing performance was high. In particular, in Examples 19 to 24, the HLB of the nonionic surfactant exceeded 18, but the 25% reduction time exceeded 200 seconds only by containing 5 parts, and it was confirmed that even a small content caused the fire-extinguishing performance to be high.

TABLE 4

| | HLB | Example 19 | Example 20 | Example 21 | Example 22 | Example 23 | Example 24 |
|---|---|---|---|---|---|---|---|
| Triethanolamine lauryl | | 22 | 22 | 22 | 22 | 22 | 22 |
| sulfate | | | | | | | |
| Lauryldimethylamine oxide | | 1.8 | 1.8 | 1.8 | 1.8 | 1.8 | 1.8 |
| Butyl carbitol | | 37 | 37 | 37 | 37 | 37 | 37 |
| Myristyl alcohol | | 1 | 1 | 1 | 1 | 1 | 1 |
| Triethanolamine | | 2 | 2 | 2 | 2 | 2 | 2 |
| Polyoxyethylene (41) lauryl | 18.1 | 3.5 | 7 | 14 | | | |
| ether | | | | | | | |
| Polyoxyethylene (35 to 65) | 18.5 | | | | 3 | 6 | 12 |
| undecyl ether | | | | | | | |
| Water | | 37.7 | 39.2 | 42.2 | 38.2 | 40.2 | 44.2 |
| Total | | 105 | 110 | 120 | 105 | 110 | 120 |
| Expansion ratio in synthetic | | 11 | 10.75 | 11.25 | 9.5 | 11.2 | 12 |
| seawater | | | | | | | |
| 25% reduction time in | | 222.5 | 229.5 | 286.5 | 203 | 243 | 318.5 |
| synthetic seawater (s) | | | | | | | |

The nonionic surfactants in Examples 19 to 24 are converted in mass % as follows.

In the case of Example 19 (105 parts in total): 3.3 mass %

In the case of Example 20 (110 parts in total): 6.4 mass %

In the case of Example 21 (120 parts in total): 11.7 mass %

In the case of Example 22 (105 parts in total): 2.9 mass %

In the case of Example 23 (110 parts in total): 5.5 mass %

In the case of Example 24 (120 parts in total): 10.0 mass %

In Comparative Examples 2 to 4, the content of polyoxyethylene (9) lauryl ether having HLB of 13.6 was changed.

TABLE 5

| | | Comparative | Comparative | Comparative |
|---|---|---|---|---|
| | HLB | Example 2 | Example 3 | Example 4 |
| Triethanolamine lauryl sulfate | | 22 | 22 | 22 |
| Lauryldimethylamine oxide | | 1.8 | 1.8 | 1.8 |
| Butyl carbitol | | 37 | 37 | 37 |
| Myristyl alcohol | | 1 | 1 | 1 |
| Triethanolamine | | 2 | 2 | 2 |
| Polyoxyethylene (9) lauryl ether | 13.6 | 5 | 10 | 20 |
| Water | | 36.2 | 36.2 | 36.2 |
| Total | | 105 | 110 | 120 |
| Expansion ratio in synthetic | | 7.9 | 8.7 | 8.6 |
| seawater | | | | |
| 25% reduction time in synthetic | | 126.5 | 148 | 77 |
| seawater (s) | | | | |

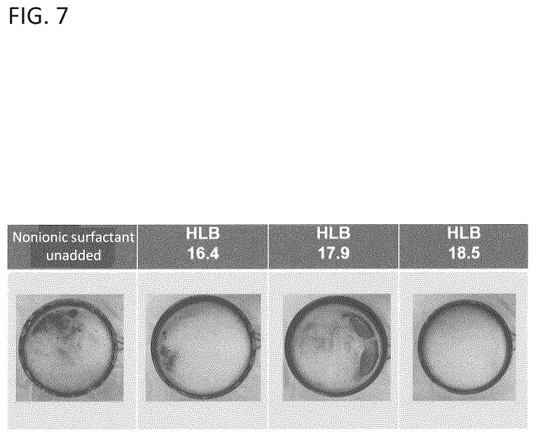

The fire-extinguishing time when 5 parts (4.8 mass %) of the nonionic surfactant was contained was as follows. It was confirmed that the higher the HLB is, the shorter the fire-extinguishing time is. Particularly when the HLB is 18 or more, the fire-extinguishing time was significantly shortened. In addition, a photograph of the foam after extinguishing the fire is shown in FIG. 7, and it was also confirmed that the sealing property after extinguishing the fire is better when the HLB is high.

TABLE 6

| | Fire-extinguishing time |
|---|---|
| Unadded | 58 |
| HLB 16.4 | 52 |
| HLB 17.9 | 44 |
| HLB 18.5 | 31 |

The fire-extinguishing time when the content of the nonionic surfactant having HLB of 18.5 was changed was as follows. When the nonionic surfactant is contained in an amount of 2 parts (Example 25), the nonionic surfactant is contained in an amount of 2.0 (=2/102) mass %.

TABLE 7

| | Fire-extinguishing time |
|---|---|
| 2 parts (2.0 mass %) | 35 |
| 5 parts (4.8 mass %) | 31 |
| 10 parts (9.1 mass %) | 31 |
| 20 parts (16.7 mass %) | 29 |

As is apparent from the results of Comparative Examples 1 to 4 and Examples 1 to 24, it was confirmed that containing a nonionic surfactant having HLB of 15 or more improved the foamability and the foam retention even in synthetic seawater. In particular, when the nonionic surfactant having HLB of 18 or more was used, the fire-extinguishing time was shortened even with a small amount (see Table 7).

The description of embodiment and variation, and the disclosure of the figures described above are merely examples for describing the invention described in the claims, and the invention described in the claims is not limited by the description of the embodiments or the disclosure of the figures described above. Further, the recitation in the claims at the time of application is only an example, and the recitation of the claims can be changed as appropriate based on the disclosure in the specification.

1. A foam extinguishing agent raw liquid comprising 14 mass % or more of an anionic surfactant, 0.2 mass % or more and 10 mass % or less of an amphoteric surfactant, 1.0 mass % or more of a nonionic surfactant having HLB of 15 or more, and a solvent, and
wherein the foam extinguishing agent raw liquid does not contain a fluorine-based surfactant.

2. The foam extinguishing agent raw liquid according to claim 1,
wherein the nonionic surfactant includes polyoxyethylene lauryl ether, polyoxyethylene alkyl ether, polyoxyethylene oleyl ether, polyoxyethylene stearyl ether, or polyoxyethylene (7 to 65) undecyl ether.

3. The foam extinguishing agent raw liquid according to claim 1, wherein the nonionic surfactant has HLB of 18 or more.

4. The foam fire-extinguishing agent raw liquid as claimed in claim 1,
wherein the foam extinguishing agent raw liquid does not include an inorganic powder, a silicone component, a metal soap, and a carbonate.
